(19) United States
(12) Patent Application Publication
(10) Pub. No.: US 2016/0114514 A1
(43) Pub. Date: Apr. 28, 2016

(54) TEMPERATURE CONTROL DEVICE OF INJECTION MOLDING MACHINE

(71) Applicant: NISSEI PLASTIC INDUSTRIAL CO., LTD., Nagano-ken (JP)

(72) Inventors: Takashi Hakoda, Nagano-ken (JP); Toshimi Kato, Nagano-ken (JP); Hiroyuki Miyazaki, Nagano-ken (JP)

(73) Assignee: NISSEI PLASTIC INDUSTRIAL CO., LTD., Nagano-ken (JP)

(21) Appl. No.: 14/922,922

(22) Filed: Oct. 26, 2015

(30) Foreign Application Priority Data
Oct. 27, 2014 (JP) 2014-218621

(51) Int. Cl. B29C 45/78; B29C 45/74

(52) U.S. Cl. CPC B29C 45/78; B29C 45/74; B29C 2945/7604; B29C 2945/7619; B29C 2945/76367; B29C 2945/76531; B29C 2945/76668; B29C 2945/76846

(57) ABSTRACT

A PID control system 10 is included to determine the deviation value e of a detection temperature PV and a set temperature SV, to perform PID control such that the deviation value e becomes zero and to output, to the corresponding heating portion 4 or cooling portion 5, only one of a heating operation amount yh which is generated by an I operation output, a D operation output, the deviation value e and a heating side proportional band to perform control on the heating portion 4 and a cooling operation amount yc which is generated by an I operation output, a D operation output, the deviation value e and a cooling side proportional band to perform control on the cooling portions 5, whichever amount is relatively larger.

### 1. TECHNICAL FIELD

This invention relates to a temperature control device of an injection molding machine that is suitably used when a heating cylinder is heated or cooled by a heating portion and a cooling portion provided on the outer circumferential surface of the heating cylinder.

### 2. BACKGROUND ART

In general, an injection molding machine includes an injection device that injects a molten resin into a mold to fill the mold. In this case, in the injection device, a heating cylinder having an injection nozzle at a front end and a hopper at a back portion is included, a screw is inserted through the interior of the heating cylinder and a heating device is provided on the outer circumferential surface of the heating cylinder. In this way, a solid pellet supplied from the hopper into the heating cylinder is plasticized and kneaded through shearing produced by the rotation of the screw and heating produced by the heating cylinder, and thus the molten resin to be injected and filled into the mold is generated. On the other hand, in terms of the multi-functionality of the heating device, a heating device is also proposed to which, in addition to a general heating function, a forced cooling function is added, and a mounted temperature control device performs control of both the heating function and the forced cooling function.

Conventionally, as the temperature control device of an injection molding machine to which such a cooling function is added, a temperature control device that is disclosed in patent literature 1 and that is present in a heating cylinder including a heat retention cover-equipped heater is known. This temperature control device has the purpose of reducing the amount of heat discharged from the heater and rapidly lowering the temperature of the heating cylinder. Specifically, a heat retention cover in which a heat retention material having a ventilation property is lined is attached to the outer wall surface of the heater attached to the heating cylinder, a half member in which a heat retention material is lined is coupled by a hinge portion to the heat retention cover so as to be freely opened and closed, and when a tightening bolt screwed to a boss portion is tightened at the time of attachment to the outer wall surface of the heater, both the half members are made to communicate with each other on a mating surface to form a ventilation path. Then, an inlet is provided in one of the half members, an outlet is provided in the other half member, a fan is provided in the outlet and is rotated to discharge air through the outlet, outside air is sucked through the inlet, and thus air-cooling is performed. In this way, when the temperature of the heating cylinder is equal to a set temperature, both the heater and the fan are turned off. When the temperature of the heating cylinder is lower than the set temperature, the heater is turned on and the fan is turned off to perform a heating operation, and when the temperature of the heating cylinder is higher than the set temperature, the heater is turned off and the fan is turned on to perform a cooling operation.

### SUMMARY OF INVENTION

### Technical Problem

However, the temperature control device of the injection molding machine to which the above-described cooling function disclosed in patent literature 1 is added has the following problems.

Specifically, in the case of the injection molding machine disclosed in patent document 1, since the heat retention cover is fitted to prevent unnecessary heat discharge of the heating cylinder, a side effect is also produced by the fitting of the heat retention cover. More specifically, the temperature of the heating cylinder is prevented from being lowered rapidly even when the temperature is desired to be lowered, meaning that patent literature 1 has an object to solve this problem. Hence, although it is possible to achieve the object thereof in terms of removal of so-called remnant heat due to the heat retention cover, in the case of use in another applications such as in which temperature control with high accuracy in cooperation with heating control is performed, such use is difficult in terms of responsiveness and controllability; therefore the invention of patent document 1 lacks versatility and applicability (development).

On the other hand, in the case of the injection molding machine, depending on the type of resin material, shear heat when the resin material is sheared by the rotation of a screw may be high. In this case, it is difficult to perform accurate temperature control by control only with the heating function, and thus the quality of a molded product is adversely affected. Productivity is also affected and thus, for example, the yield is lowered.

Hence, conventionally, in order to cope with this problem, the addition of the cooling function is required and control in cooperation with the cooling function and the heating function must be performed to perform highly stable control while avoiding a hunting phenomenon. Further, the commercialization of a temperature control device excellent in energy saving while acquiring high control accuracy is also required.

This invention has an object to provide a temperature control device of an injection molding machine that solves the problems present in the background art described above.

### Solution to Problem

In order to solve the problems described above, according to this invention, there is provided a temperature control device 1 of an injection molding machine M that includes a molding controller E which detects, with a temperature sensor 3, a heating temperature of a predetermined portion of a heating cylinder 2 and which controls a heating portion 4 heating the predetermined portion and a cooling portion 5 cooling the predetermined portion such that the detection temperature PV is equal to a preset set temperature SV, the temperature control device including: a PID control system 10 that determines a deviation value e of the detection temperature PV and the set temperature SV, that performs PID control such that the deviation value e becomes zero and that outputs, to the heating portion 4 or the cooling portion 5 corresponding thereto, only one of a heating operation amount yh which is generated by an I operation output, a D operation output, the deviation value e and a heating side proportional band to perform control on the heating portion 4 and a cooling operation amount yc which is generated by the I operation output, the D operation output, the deviation value e and a cooling side proportional band to perform control on the cooling portion 5, whichever amount is relatively larger.

### Advantageous Effects of Invention

Hence, in the temperature control device 1 of the injection molding machine M having such a configuration and according to this invention, the following significant effects are achieved.

(1) The PID control system 10 is included to determine the deviation value e of the detection temperature PV and the set temperature SV, to perform the PID control such that the deviation value e becomes zero and to output, to the corresponding heating portion 4 or cooling portion 5, only one of the heating operation amount yh which is generated by the I operation output, the D operation output, the deviation value e and the heating side proportional band to perform control on the heating portion 4 and the cooling operation amount yc which is generated by the I operation output, the D operation output, the deviation value e and the cooling side proportional band to perform control on the cooling portions 5, whichever amount is relatively larger, with the result that it is possible to perform control in cooperation with the cooling function and the heating function to perform highly stable control while avoiding a hunting phenomenon. Moreover, it is possible to realize the temperature control device 1 having excellent energy saving performance while acquiring high control accuracy, and in particular, the temperature control device 1 is optimal for use in the production of a resin material having a large amount of shear heat when the resin material is sheared by the rotation of the screw.

(2) In a preferred aspect, as the D operation output, the detection temperature PV is differentiated with respect to time, the positive and negative thereof are inverted and the result is output, the individually set reciprocals of the heating side proportional band and the cooling side proportional band are used and the positive and negative of the cooling side proportional band are inverted, with the result that it is possible to realize the optimum form in terms of execution of signal processing at the time of establishment of the intended temperature control device 1.

(3) In a preferred aspect, when the I operation output and the D operation output for generating the heating operation amount yh and the I operation output and the D operation output for generating the cooling operation amount yc are used in common, it is possible to perform further simplification in terms of establishment of a circuit at the time of establishment of the intended temperature control device 1.

(4) In a preferred aspect, since a selection means 13 for stopping the control by the cooling operation amount yc is provided and thus it is possible to arbitrarily stop the control by the cooling operation amount yc, when a case where the cooling function is not necessary such as in which a resin material that little produces shear heat is used is assumed, the control by the cooling operation amount yc is stopped and thus a waste of energy consumption is eliminated, with the result that it is possible to enhance energy saving.

(5) In a preferred aspect, when a heating portion 4 is formed, a band heater 11 incorporating a heating member 12 therewithin and fitted by being wound on an outer circumferential surface 2f of a heating cylinder 2 is used, and thus it is possible to easily establish a cooling portion 5 that is the optimum form combined with the attachment structure (heating structure) of the band heater 11 which conducts heat by surface contact with the outer circumferential surface 2f of the heating cylinder 2.

(6) In a preferred aspect, when the cooling portion 5 is formed, a panel member 5p formed of a material R having thermal conductivity is interposed between the band heater 11 and the outer circumferential surface 2f of the heating cylinder 2, and an air path 6 for air cooling is formed in the panel member 5p, and in the air path 6, an air outlet and inlet portion 8 allowing air A to be passed from an air supply portion 7 is provided, with the result that the heating structure is hardly sacrificed by the heating portion 4 (the band heater 11). Hence, it is possible to minimize a decrease in heat loss (heating efficiency) and furthermore a decrease in the responsiveness of the temperature control and a decrease in controllability, and thus it is possible to sufficiently achieve both the heating function and the cooling (air-cooling) function. Even when the cooling portion 5 is added to the heating portion 4 provided on the outer circumferential surface 2f of the heating cylinder 2, since it is almost unnecessary to change the outside diameter of the heating portion 4, it is possible to avoid a failure in which the size of the heating cylinder 2, and hence the size of the injection molding machine M, is increased. In other words, even when a cooling structure is added to the already provided heating structure, it is possible to avoid a failure in which the size of a molding facility is uselessly increased and the space efficiency is lowered.

(7) In a preferred aspect, a predetermined portion of the heating cylinder 2 is applied to at least one or two or more of a metering zone Zm, a compression zone Zc and a feeding zone Zf, and thus in particular, it is possible to cover the portion where shear heat is produced when the resin material is sheared by the rotation of the screw, with the result that it is possible to reliably acquire effectiveness when the temperature control device 1 is used.

### BRIEF DESCRIPTION OF DRAWINGS

FIG. 1: A block system diagram of a drive control system forming a temperature control device according to a preferred embodiment of this invention;

FIG. 2: A system diagram of the entire control system including a cross-sectional side view of an injection device in an injection molding machine including the temperature control device;

FIG. 3: A block system diagram of a PID control system in the temperature control device;

FIG. 4: An exploded perspective view showing the appearance of the constituent components of a heating device (a heating portion and a cooling portion) which is a target to be controlled by the temperature control device;

FIG. 5: An external perspective view of a panel member used in the cooling portion included in the heating device;

FIG. 6: An external perspective view of the heating device;

FIG. 7: A cross-sectional front view of a heating cylinder of the injection molding machine including the heating device;

FIG. 8: An image configuration diagram showing a temperature monitoring screen displayed on a display of a molding controller forming the temperature control device;

FIG. 9: An image configuration diagram of a temperature control setting screen displayed on the temperature monitoring screen;

FIG. 10: A diagram showing variations in detection temperature and control output with time when control is performed by the temperature control device; and

FIG. 11: A diagram showing variations in the detection temperature and control signal with time when control is performed by a temperature control device according to background art.

### DESCRIPTION OF EMBODIMENTS

A detailed description will now be given using a preferred embodiment according to this invention with reference to the drawings. The accompanying drawings are not intended to specify this invention but are intended to facilitate the understanding of this invention. The detailed description of known portions will be omitted so that the obscurity of the invention is avoided.

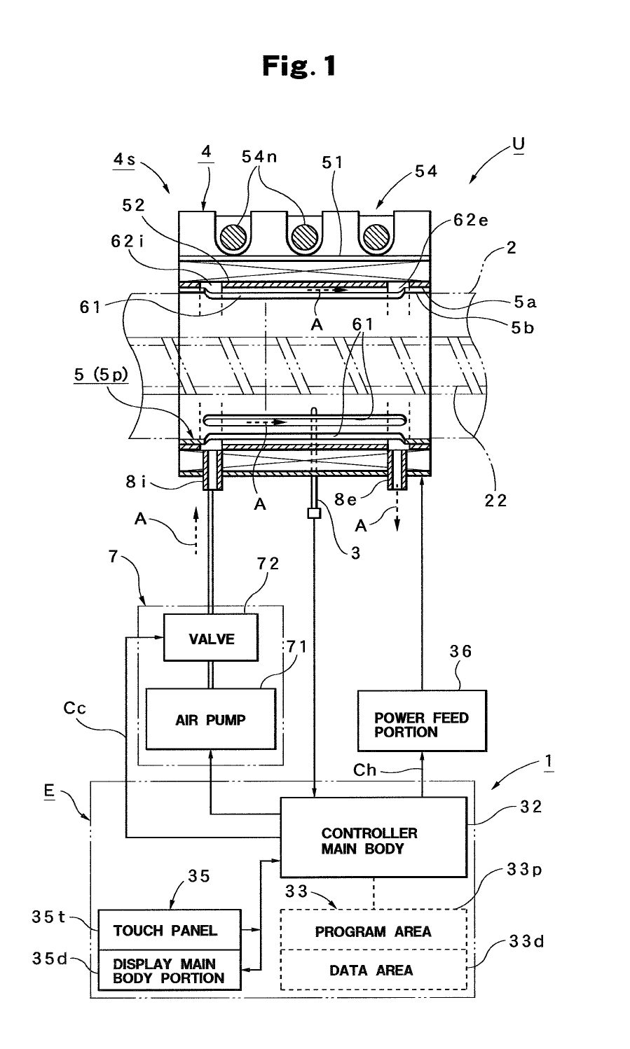

The outline of a preferred injection molding machine M using a temperature control device 1 according to this embodiment will first be described with reference to FIGS. 1, 2 and 4 to 7.

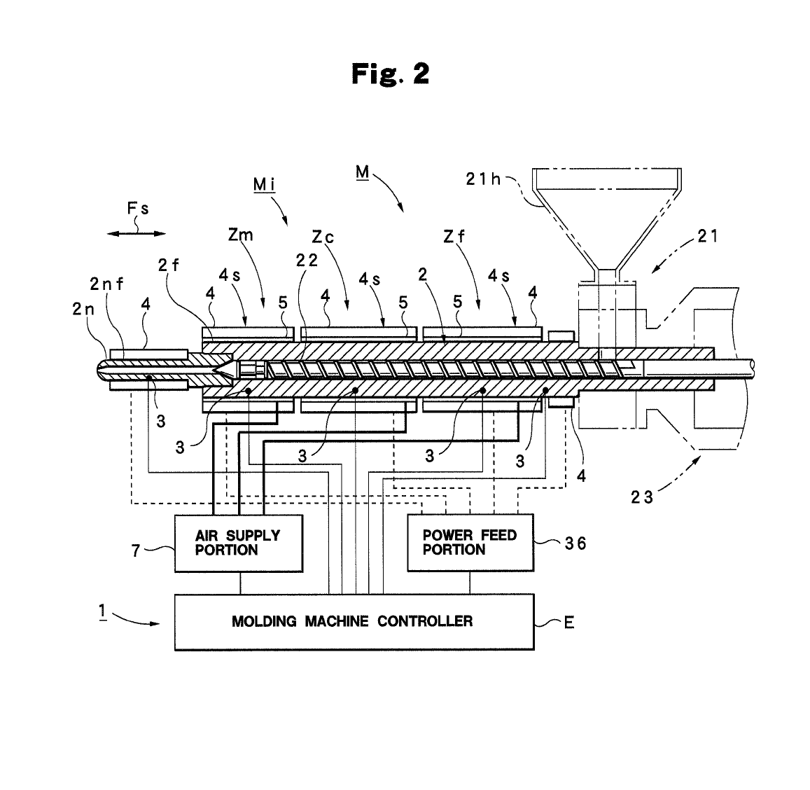

In FIG. 2, Mi represents an injection device, and the injection device Mi and an unillustrated mold clamping device form the injection molding machine M. The injection device Mi includes a heating cylinder 2. The heating cylinder 2 has an injection nozzle 2n at a front end and the back end of the heating cylinder 2 is coupled to a material supply portion 21 having a hopper 21h for supplying a molding material into the heating cylinder 2. A screw 22 is inserted into the heating cylinder 2. The back end of the screw 22 is extended out to the back of the material supply portion 21 and thus the screw 22 is connected to a screw drive portion 23 which is driven to rotate and is driven to move forward and backward and whose detailed drawing is omitted.

On the outer circumferential surface 2f of the heating cylinder 2 and the outer circumferential surface 2nf of the injection nozzle 2n, a heating device U is provided that is a target to be controlled by the heating device 1 according to this embodiment. The heating device U includes heating portions 4 that are sequentially arranged along an axial direction Fs. Specifically, five heating portions 4 are included that are fitted to the injection nozzle 2n (nozzle zone), the front portion of the heating cylinder 2 (metering zone Zm), the intermediate portion of the heating cylinder 2 (compression zone Zc), the back portion of the heating cylinder 2 (feeding zone Zf) and the final portion of the heating cylinder 2.

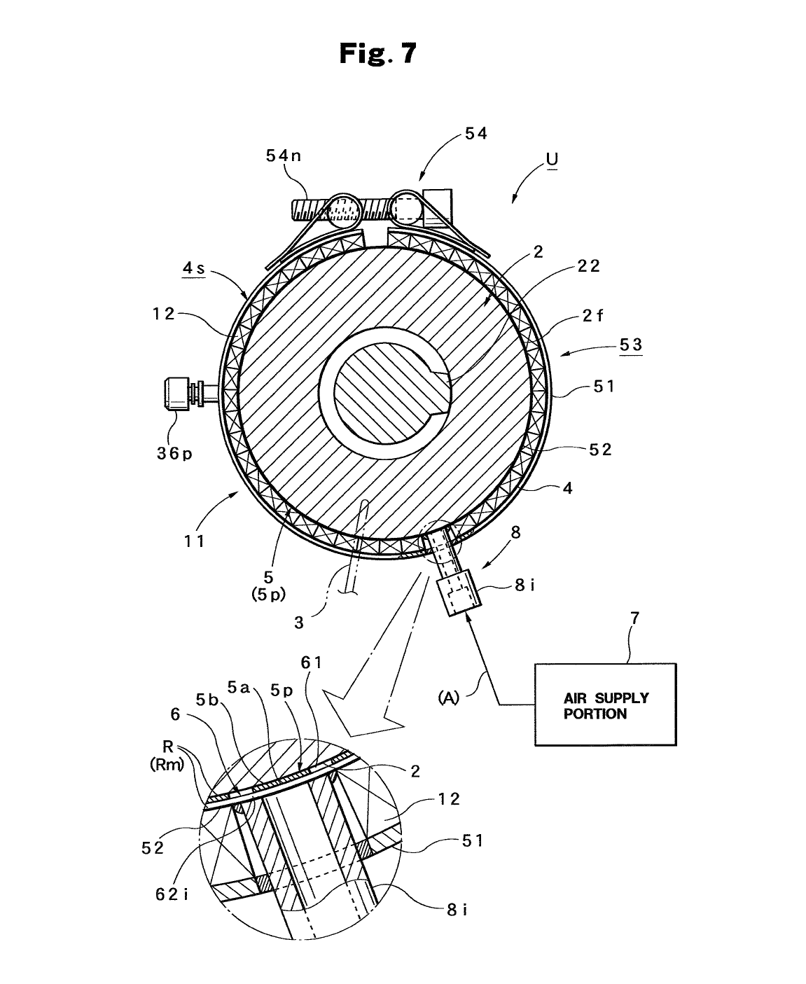

In this case, the heating portion 4 fitted to the outer circumferential surface 2nf of the injection nozzle 2n incorporates a heating member 12 therewithin, and uses a band heater 11 (see FIG. 7) fitted by being wound on the outer circumferential surface 2nf of the injection nozzle 2n without the band heater 11 being processed. In other words, the heating portion 4 is formed as a normal heating portion using the band heater 11. Likewise, the heating portion 4 fitted to the final portion of the heating cylinder 2 incorporates the heating member 12 therewithin, uses the band heater 11 (see FIG. 7) fitted by being wound on the outer circumferential surface 2f of the heating cylinder 2 without the band heater 11 being processed and is formed as a normal heating portion.

By contrast, cooling portions 5 are provided in each of the heating portions 4 that heat the metering zone Zm, the compression zone Zc and the feeding zone Zf in the heating cylinder 2, and the heating portions 4 are formed as heating and cooling portion 4s. As described above, one or two or more heating portions 4 that heat, at least, the metering zone Zm, the compression zone Zc and the feeding zone Zf in the heating cylinder 2 are formed as the heating and cooling portion 4s, and thus by the air-cooling function of the heating and cooling portion 4s, it is particularly possible to reduce a unnecessary temperature increase in a portion where shear heat is generated when a resin material is sheared by the rotation of the screw 22. In this way, it is advantageously possible to realize satisfactory temperature control and to contribute to further enhancement of molding quality.

The configuration of the heating and cooling portion 4s will be specifically described below. In the basic configuration of the heating and cooling portion 4s, a panel member 5p formed of a material R having thermal conductivity is interposed between the heating portion 4 and the outer circumferential surface 2f of the heating cylinder 2. An air path 6 for air cooling is formed in the panel member 5p and in the air path 6, an air outlet and inlet portion 8 that allows air A to be passed from an external air supply portion 7 is provided.

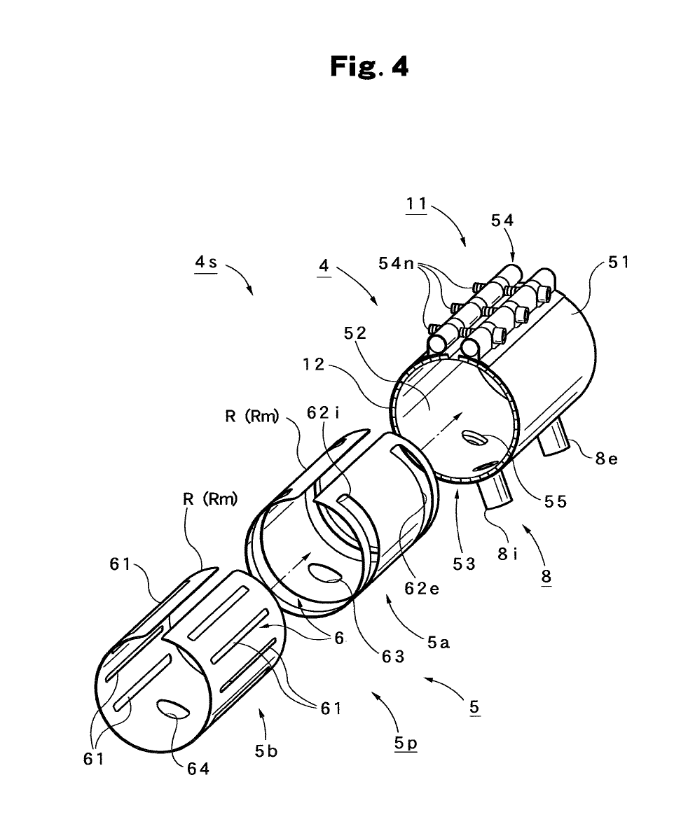

In this case, in the heating portion 4, as with the heating portion 4 of the injection nozzle 2n described above, the band heater 11 is used that incorporates the heating member 12 therewithin and that is fitted by being wound on the outer circumferential surface 2f of the heating cylinder 2. In the band heater 11, as shown in FIG. 4, the heating member 12 is sandwiched between a rectangular outer panel portion 51 and a rectangular inner panel portion 52 to form the entire member as a flexible band-shaped member 53. Both ends of the band-shaped member 53 in the longitudinal direction (circumferential direction) can be coupled with a coupling portion 54. The coupling portion 54 includes a plurality of coupling screws 54n, and as shown in FIG. 4, the coupling screws 54n are inserted into an insertion hole portion provided at one end in the longitudinal direction of the band-shaped member 53, and are thereafter each screwed to a nut portion provided at the other end in the longitudinal direction. Since the coupling portion 54 uses the coupling screws 54n to perform the coupling, the coupling portion 54 has not only the function of coupling both ends in the longitudinal direction of the band-shaped member 53 but also has a removal function capable of removal and furthermore the function of adjusting the magnitude (the absolute magnitude and the relative magnitude in the position in the axial direction) of the tightening strength. As described above, the band heater 11 is used as the heating portion 4, and thus it is possible to easily establish the cooling portion 5 that is the optimum form combined with the attachment structure (heating structure) of the band heater 11 which conducts heat by surface contact with the outer circumferential surface 2f of the heating cylinder 2. Reference numeral 55 represents a sensor insertion hole provided in the band-shaped member 53.

On the other hand, in the panel member 5p, a thermally conductive metal material Rm is used as the material R having thermal conductivity. As the thermally conductive metal material Rm, a stainless material is preferable. When as described above, the thermally conductive metal material Rm is used as the material R, since it is possible to utilize a stainless plate or the like having satisfactory thermal conductivity, flexibility and processability, an air-cooling action and a heating action necessary for material surfaces are acquired, and the optimum form can advantageously be achieved in terms of acquiring satisfactory manufacturability and fitting property.

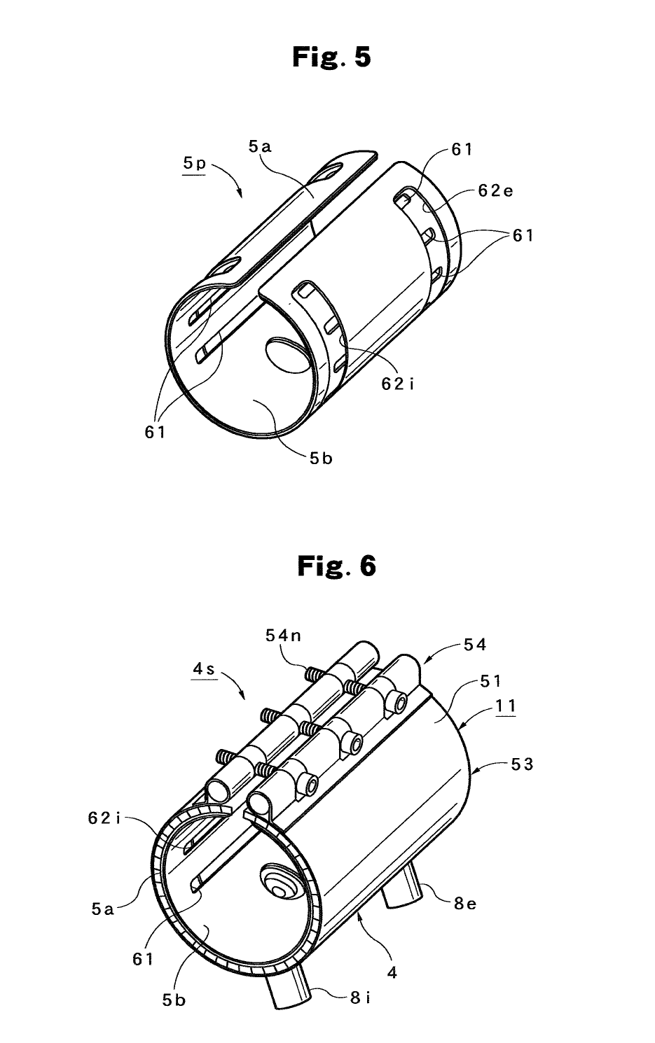

In the panel member 5p, as shown in FIGS. 4 and 5, two panel members 5a and 5b, that is, a first panel member 5a and a second panel member 5b are prepared, and the two panel members 5a and 5b are overlaid to form the panel member 5. When as described above, the two panel members 5a and 5b are overlaid to achieve the configuration, since two (in general, a plurality of) panel members 5a and 5b in which different path portions are formed can be combined in particular, the flexibility of the design is enhanced, with the result that various air paths 6 can be easily formed. In this way, it is advantageous to easily optimize the air path 6 corresponding to the dimensions of the heating cylinder 2. Preferably, the sizes of the first panel member 5a and the second panel member 5b are made substantially equal to that of the inner panel portion 52 of the band heater 11 described previously, and the thicknesses thereof are made to fall within a range of 0.5 to 2 mm (in the illustrated example, 1 mm). In this way, in terms of not only the selection of the material or the like but also the thickness of layers, it is possible to effectively acquire necessary thermal conductivity, flexibility and processability.

As shown in FIG. 4, in the second panel member 5b, a plurality of (in the illustrated example, eight) slits 61 serving as the path portions along the direction of the short side (the axial direction Fs) are formed by being punched a predetermined distance apart in the longitudinal direction, and in the first panel member 5a, two slits 62i and 62e serving as the path portions along the longitudinal direction are formed by being punched on both sides in the direction of the short side. In this way, when the first panel member 5a and the second panel member 5b are overlaid, the slit 62i on one side serves as the inlet side of air and communicates with the side of one end of the slits 61 and the slit 62e on the other side serves as the outlet side of air, with the result that the intended air path 6 communicating with the side of the other end of the slits 61 is formed. In this way, the panel members 5a and 5b are formed by being punched to form the air path 6, and thus the air path 6 can be provided by a simple manufacturing process having a small number of steps, with the result that the intended panel member 5p can be obtained easily and inexpensively. The width, the interval, the shape and the like of the slits 61, 62i and 62e can be arbitrarily selected according to the cooling target and the like. Reference numbers 63 and 64 in the figure represent the sensor insertion holes formed in the panel members 5a and 5b. The positions of the sensor insertion holes 63 and 64 coincide with the position of the sensor insertion hole 55 provided in the band heater 11.

Furthermore, the air outlet and inlet portion 8 is formed with an air inlet portion 8i and an air outlet portion 8e. As shown in FIG. 6, the air inlet portion 8i and the air outlet portion 8e are pipe-type joints, and as shown in FIG. 7, the outer panel portion 51 or the inner panel portion 52 of the band-shaped member 53 is fixed, and thus an inner end is made to face the same inner circumferential surface of the inner panel portion 52. Here, the assembly position of the first panel member 5a and the second panel member 5b is selected such that the air inlet portion 8i communicates with the slit 62i on one side, and that the air outlet portion 8e communicates with the slit 62e on the other side.

Hence, the heating device U having the structure described above can be easily assembled as follows.

The band heater 11 in a state where the coupling screws 54n of the coupling portion 54 are removed is first prepared. Then, the inner panel portion 52 of the band-shaped member 53 in the band heater 11 is faced upward, the first panel member 5a is placed on the upper surface of the inner panel portion 52 so as to overlay thereon and furthermore, the second panel member 5b is placed on the upper surface of the first panel member 5a so as to be overlaid thereon.

Then, the band-shaped member 53 in this state is wound on the outer circumferential surface 2f of the front portion of the heating cylinder 2 such that the second panel member 5b makes contact with the outer circumferential surface 2f of the heating cylinder 2, and both ends in the longitudinal direction of the wound band-shaped member 53 are coupled with the coupling screws 54n. Since in this case, the attachment is substantially the same as the attachment of a normal band heater 11, it is possible to easily perform the attachment. Here, the amount of rotation of the coupling screws 54n is varied, the magnitude (the absolute magnitude and the relative magnitude in the position in the axial direction) of the tightening strength is adjusted, and the relative positions of the first panel member 5a and the second panel member 5b with respect to the band heater 11 are adjusted.

In this way, the attachment of the band heater 11, in which the panel member 5p formed with the first panel member 5a and the second panel member 5b is interposed, to the outer circumferential surface 2f of the heating cylinder 2 is completed, and thus the heating device U shown in FIG. 6 is formed. Then, as shown in FIG. 1, a connection is made such that the air A can be supplied to the air inlet portion 8i from the air supply portion 7, and the air outlet portion 8e remains in an opened state. An exhaust pipe may be connected to the air outlet portion 8e so that the exhaust position and the exhaust direction are changed. In this case, since the air supply portion 7 includes an air pump 71 and a valve 72, the air discharge port of the air pump 71 is connected to the air inlet portion 8i through a pipe along which the valve 72 is connected halfway. As the air pump 71, a common air pump installed in factory facilities can be used. Although the method of attaching one heating and cooling portion 4s is described above, it is possible to attach the other heating and cooling portions 4s in the same manner.

As described above, in the heating device U, when the cooling portion 5 is formed, the panel member 5p formed of the material R having thermal conductivity is interposed between the band heater 11 and the outer circumferential surface 2f of the heating cylinder 2, and the air path 6 for air cooling is formed in the panel member 5p. Further, the air outlet and inlet portion 8 allowing the air A to be passed from the air supply portion 7 is provided in the air path 6, with the result that the heating structure is hardly sacrificed by the heating portion 4 (the band heater 11). Hence, it is possible to minimize a decrease in heat loss (heating efficiency) and furthermore a decrease in the responsiveness of the temperature control and a decrease in controllability, and thus it is possible to sufficiently achieve both the heating function and the cooling (air-cooling) function. Even when the cooling portion 5 is added to the heating portion 4 provided on the outer circumferential surface 2f of the heating cylinder 2, since it is almost unnecessary to change the outside diameter of the heating portion 4, it is possible to avoid a failure in which the size of the heating cylinder 2, and hence the size of the injection molding machine M, is increased. In other words, even when a cooling structure is added to the already provided heating structure, it is possible to avoid a failure in which the size of a molding facility is uselessly increased and the space efficiency is lowered.

A molding machine controller E forming the temperature control device 1 according to this embodiment including the drive control system of the heating device U will be described next with reference to FIGS. 1 to 3.

FIGS. 1 and 2 show the molding machine controller E that is mounted on the injection molding machine M. As shown in FIG. 1, the molding machine controller E basically includes a controller main body 32 incorporating hardware such as a CPU and an internal memory 33 such as a hard disk managed by the controller main body 32. Hence, the molding machine controller E is formed as a computer system, and has the function of controlling the entire injection molding machine M.

In this case, the internal memory 33 has a data area 33d where various types of data can be written and a program area 33p where various types of programs can be stored. In the program area 33p, a PLC program and a HMI program are stored, and various types of processing programs for performing various types of computation processing and various types of control processing (sequence control) are also stored. Hence, the stored processing programs include a sequence control program related to temperature control for making the heating device U of this embodiment function. The PLC program is software for realizing sequence operations in various types of steps in the injection molding machine M, the monitoring of the injection molding machine M and the like, and the HMI program is software for realizing the setting and display of the operation parameters of the injection molding machine M, the display of operation monitoring data on the injection molding machine M, and the like. Meanwhile, a display 35 is connected to the molding machine controller E. The display 35 is formed with a display main body portion 35d that performs various types of display and a touch panel portion 35t that is provided in the display main body portion 35d to perform various types of input.

On the other hand, as shown in FIG. 1, the band heater 11 of the heating and cooling portion 4s is connected to a power feed portion 36. Reference numeral 36p in FIG. 7 represents a connection terminal for the power feed portion 36 of the band heater 11. A heating control signal Ch is fed to the power feed portion 36 from the molding machine controller E. A cooling control signal Cc is fed to the air pump 71 and the valve 72 described previously from the molding machine controller E. Furthermore, in the heating cylinder 2, a temperature sensor 3 is provided that uses a thermocouple to which the band heater 11 is attached and which detects the temperature of the metering zone Zm. In this case, the temperature sensor 3 is fitted by being inserted into a fitting hole formed in the outer circumferential surface 2f of the heating cylinder 2. Then, the result of the detection of the temperature sensor 3 is fed to the molding machine controller E.

Although the drive control system of the heating and cooling portion 4s is described above, the other heating and cooling portions 4s are configured (connected) in the same manner. Since each of the injection nozzle 2n and the heating portion 4 in the final portion of the heating cylinder 2 uses only the band heater 11, they are connected to the power feed portion 36. FIG. 2 shows the entire connection system in the injection molding machine M (the injection device Mi).

The configuration of the temperature control device 1 according to this embodiment will be specifically described next with reference to FIGS. 1 to 3, 8 and 9.

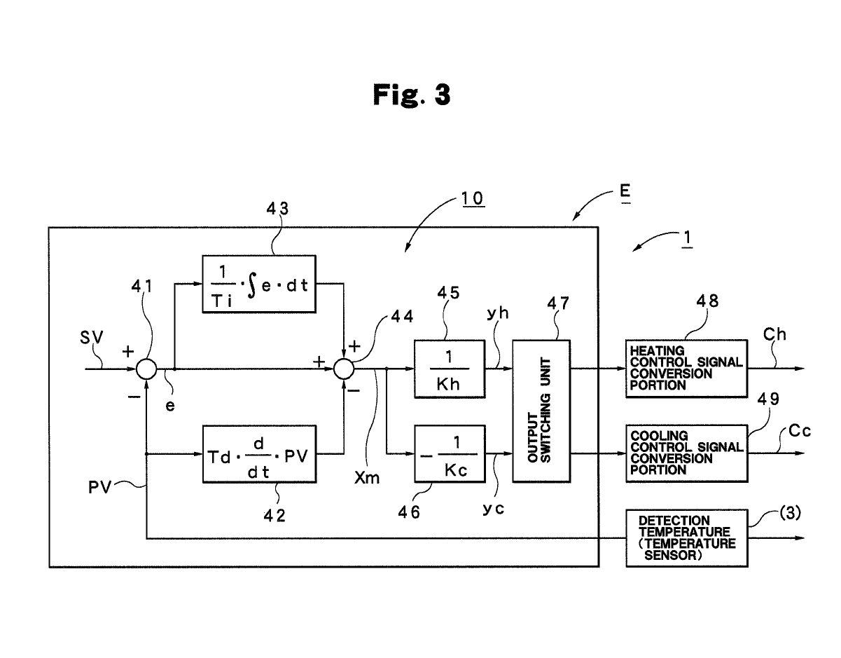

FIG. 3 shows a PID control system 10 forming the main portion of the temperature control device 1 according to this embodiment. As shown in FIG. 3, the PID control system 10 includes a deviation computation portion 41, a D operation output portion (differentiation operation output portion) 42, and an I operation output portion (integration operation output portion) 43, an addition and subtraction computation portion 44, a heating side proportional band setting portion 45, a cooling side proportional band setting portion 46 and an output switching unit 47. Reference numeral 48 represents a heating control signal conversion portion, and reference numeral 49 represents a cooling control signal conversion portion.

In this case, in the deviation computation portion 41, a detection temperature (detection value) PV obtained from the temperature sensor 3 is fed to an inverting input portion, a set temperature (set value) SV is fed to a non-inverting input portion and a deviation value e is obtained from an output portion. The deviation value e is fed to the non-inverting input portion of the addition and subtraction computation portion 44 and is also fed to the I operation output portion 43. An I operation output obtained by integrating the deviation value e with respect to time is obtained from the I operation output portion 43, and the I operation output is fed to the non-inverting input portion of the addition and subtraction computation portion 44. On the other hand, the detection temperature PV is also fed to the D operation output portion 42, and a D operation output obtained by integrating the detection temperature PV with respect to time is obtained from the D operation output portion 42. The D operation output is fed to the inverting input portion of the addition and subtraction computation portion 44.

In this way, it is possible to obtain an intermediate operation amount Xm that is obtained by adding the I operation output to the deviation value e and subtracting the D operation output therefrom. Then, the intermediate operation amount Xm is fed to the heating side proportional band setting portion 45, and a heating operation amount yh obtained by multiplying the intermediate operation amount Xm by the reciprocal of a heating side proportional band Kh is obtained from the heating side proportional band setting portion 45. Further, the intermediate operation amount Xm is fed to the cooling side proportional band setting portion 46, and a cooling operation amount yc obtained by multiplying the intermediate operation amount Xm by the reciprocal of a cooling side proportional band Kc and inverting the positive and negative is obtained from the cooling side proportional band setting portion 46.

The heating operation amount yh and the cooling operation amount yc are fed to the output switching unit 47. In the output switching unit 47, the magnitudes of the heating operation amount yh and the cooling operation amount yc are compared, and one of the heating operation amount yh and the cooling operation amount yc which is relatively larger than the other is selected and only the selected one of the heating operation amount yh and the cooling operation amount yc is output. When the heating operation amount yh is output, the heating operation amount yh is fed to the heating control signal conversion portion 48 so as to be converted into the heating control signal Ch. Specifically, the conversion is performed by a computation formula of Ch=100·yh, and the heating control signal Ch is fed to the power feed portion 36, with the result that the power feed control on the power feed portion 36 is performed. On the other hand, when the cooling operation amount yc is output, the cooling operation amount yc is fed to the cooling control signal conversion portion 49 so as to be converted into the cooling control signal Cc. In other words, the conversion is performed by a computation formula of Ch=100·yc, and the cooling control signal Cc is fed to the valve 72, with the result that opening/closing control on the valve 72 is performed.

Hence, in the PID control system 10, computation formulae [Formula 1] [Formula 2] and [Formula 3] shown below hold true.

$$\begin{matrix}e = SV - PV & [ Formula 1 ] \\ yh = \frac{1}{Kh} ( e + \frac{1}{Ti} \int e \cdot d t - td \frac{d }{d t} PV ) & [ Formula 2 ] \\ yc = \frac{1}{Kc} ( e + \frac{1}{Ti} \int e \cdot d t - Td \frac{d }{d t} PV ) x - 1 & [ Formula 3 ]\end{matrix}$$

In formulae 1 to 3, Ti represents the integration time, Td represents the differentiation time, Kh represents the heating side proportional band and Kc represents the cooling side proportional band.

According to formulae 1 to 3, as the D operation output, the detection temperature PV is differentiated with respect to time, the positive and negative thereof are inverted and the result is output. In the heating side proportional band setting portion 45 and the cooling side proportional band setting portion 46, the reciprocals of the heating side proportional band Kh and the cooling side proportional band Kc are used, and the positive and negative of the cooling side proportional band Kc are inverted. The heating side proportional band Kh and the cooling side proportional band Kc can be individually set. Furthermore, the I operation output and the D operation output for generating the heating operation amount yh and the I operation output and the D operation output for generating the cooling operation amount yc are common.

When as described above, as the D operation output, the detection temperature PV is differentiated with respect to time, the positive and negative thereof are inverted and the result is output, the reciprocals of the heating side proportional band and the cooling side proportional band that are individually set are used and the positive and negative of the cooling side proportional band are inverted, it is possible to practice the optimum form in terms of execution of signal processing at the time of establishment of the intended temperature control device 1. Furthermore, when the I operation output and the D operation output for generating the heating operation amount yh and the I operation output and the D operation output for generating the cooling operation amount yc are used in common, it is possible to perform further simplification in terms of establishment of the circuit at the time of establishment of the intended temperature control device 1.

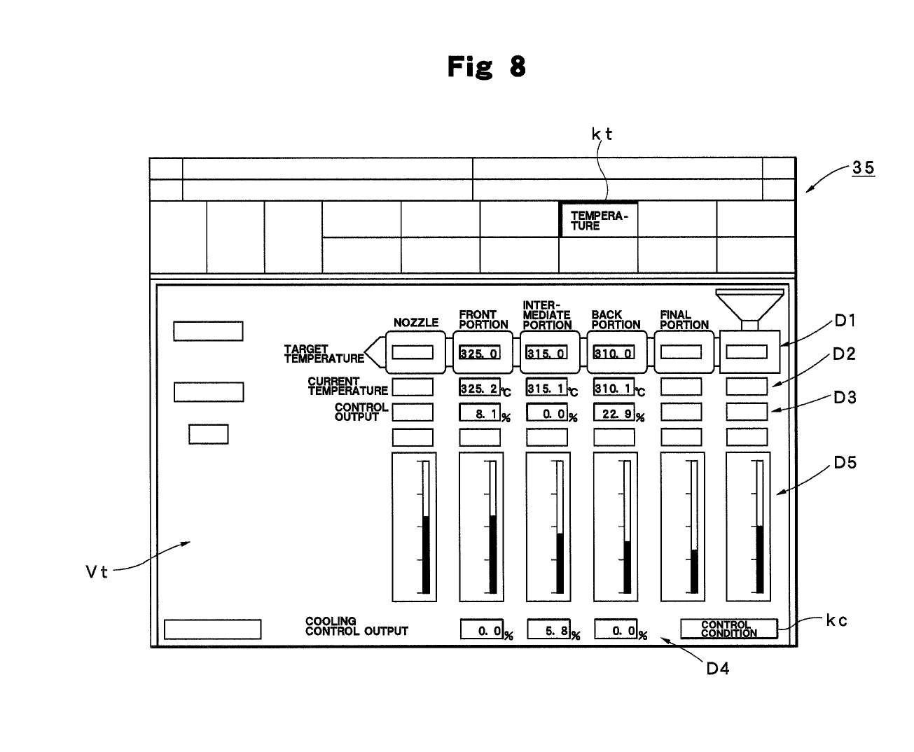

On the other hand, the temperature control device 1 according to this embodiment includes a temperature monitoring screen Vt shown in FIG. 8. The temperature monitoring screen Vt is displayed on the display 35 provided in the molding machine controller E. In this case, a screen switching key kt constantly displayed on the display 35 is selected, and thus it is possible to display the temperature monitoring screen Vt. In the temperature monitoring screen Vt, in a horizontal direction, the display areas of the injection nozzle 2n, the front portion of the heating cylinder 2, the intermediate portion of the heating cylinder 2, the back portion of the heating cylinder 2, the final portion of the heating cylinder 2 and a material chute are sequentially acquired, and in a vertical direction, a display portion D1 of a target temperature (set temperature), a display portion D2 of the current temperature, a display portion D3 of a heating control output and the like are arranged from above. In the vicinity of the bottom end of the temperature monitoring screen Vt, a display portion D4 of a cooling control output is arranged. Reference numeral D5 represents a graphic display portion of the temperature.

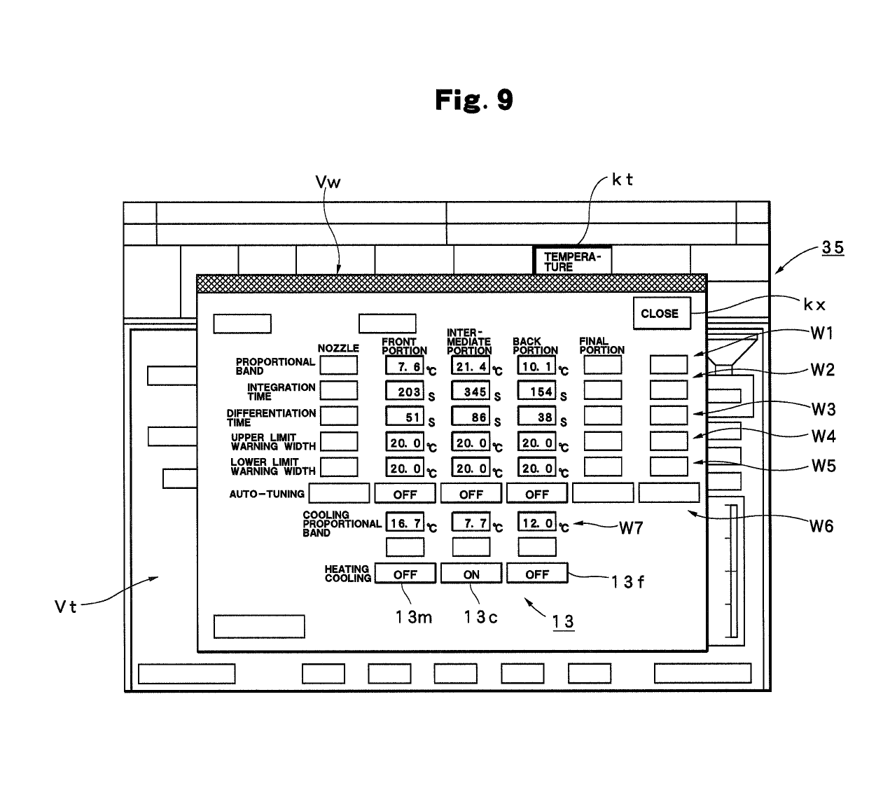

Furthermore, FIG. 9 shows a temperature control setting screen Vw that is window-displayed on the temperature monitoring screen Vt. The temperature control setting screen Vw can be displayed by turning on a control condition setting key kc on the temperature monitoring screen Vt shown in FIG. 8. In the temperature control setting screen Vw, in a horizontal direction, the display areas of the injection nozzle 2n, the front portion of the heating cylinder 2, the intermediate portion of the heating cylinder 2, the back portion of the heating cylinder 2, the final portion of the heating cylinder 2 and a material chute are sequentially acquired, and in a vertical direction, a setting portion W1 of the heating side proportional band, a setting portion W2 of the integration time, a setting portion W3 of the differentiation time, a setting portion W4 of an upper limit warning width, a setting portion W5 of a lower limit warning width, a setting key column W6 of auto-tuning and a setting portion W7 of the cooling side proportional band are arranged from above.

Reference numeral 13 represents a selection means that stops the control by the cooling operation amount yc, and the selection means 13 includes a heating and cooling selection key 13m for the front portion of the heating cylinder 2, a heating and cooling selection key 13c for the intermediate portion of the heating cylinder 2 and a heating and cooling selection key 13f for the back portion of the heating cylinder 2. In this way, for example, when the cooling selection key 13c is turned on, for the intermediate portion of the heating cylinder 2, control can be performed on both the heating portion 4 and the cooling portion 5 whereas when the cooling selection key 13c is turned off for the intermediate portion of the heating cylinder 2, control is performed only on the heating portion 4. Hence, providing such a selection means 13 makes it possible to arbitrarily stop, by selection, the control by the cooling operation amount yc, when a case where the cooling function is assumed to be not necessary, such as in which a resin material that little produces shear heat is used, the control by the cooling operation amount yc is stopped, and thus a waste of energy consumption is eliminated, with the result that it is possible to enhance energy saving. Reference numeral kx represents a “closing” key.

The operation of the temperature control device 1 according to this embodiment including the operation of the heating device U will be described next with reference to FIGS. 1 to 11.

Although in the illustrated example, the operation of the heating and cooling portion 4s in the intermediate portion of the heating cylinder 2 will be described, the other heating and cooling portions 4s perform the same operation except that the set temperatures are different.

It is now assumed that the heating control signal Ch is fed from the molding machine controller E to the power feed portion 36. Here, the valve 72 is off (closed). In this way, power is fed to the band heater 11 in the heating and cooling portion 4s. Heat generated in the band heater 11 is transmitted to the heating cylinder 2 through the panel member 5p in which the first panel member 5a and the second panel member 5b are overlaid to heat the intermediate portion of the heating cylinder 2. Although the panel member 5p is interposed between the band heater 11 and the heating cylinder 2, in the case of the illustrated example, the two stainless plates having a thickness of about 2 mm and thermal conductivity are interposed, and the air path 6 obtained by being partially punched is present in the stainless plates, with the result that thermal loss is hardly produced.

On the other hand, the heating temperature here is detected by the temperature sensor 3, as shown in FIG. 3, is fed as the detection temperature (detection value) PV to the deviation computation portion 41 and the D operation output portion 42. In this way, it is possible to obtain, from the deviation computation portion 41, the deviation value e with respect to the set value SV of the set temperature (target temperature). The deviation value e is fed to the addition and subtraction computation portion 44 and is also fed to the I operation output portion 43. Consequently, the I operation output, the deviation value e and the D operation output are fed to the addition and subtraction computation portion 44, and the intermediate operation amount Xm is obtained in the output portion of the addition and subtraction computation portion 44. In the case of the illustrated example, the integration time Ti in which the I operation output is obtained is set at 345 seconds as shown in FIG. 9, and the differentiation time Td in which the D operation output is obtained is set 86 seconds.

It is now assumed that the magnitude of the intermediate operation amount Xm is positive. In this way, the heating operation amount yh generated by the heating side proportional band setting portion 45 is positive, and the cooling operation amount yc generated by the cooling side proportional band setting portion 46 is negative. Consequently, only the heating operation amount yh which is relatively higher is output from the output switching unit 47, and is converted by the heating control signal conversion portion 48 into the heating control signal Ch. Then, the heating control signal Ch is fed to the power feed portion 36 to perform power feed control on the power feed portion 36, and thus the intermediate portion of the heating cylinder 2 is heated by the band heater 11. Since the cooling operation amount yc is negative, the output of the cooling control signal Cc is zero.

It is then assumed that the magnitude of the intermediate operation amount Xm is negative. In this way, the heating operation amount yh generated by the heating side proportional band setting portion 45 is negative, and the cooling operation amount yc generated by the cooling side proportional band setting portion 46 is positive. Consequently, only the cooling operation amount yc which is relatively higher is output from the output switching unit 47, and is converted by the cooling control signal conversion portion 49 into the cooling control signal Cc. Then, the cooling control signal Cc is fed to the valve 72 to perform opening/closing control on the valve 72. Here, since the heating operation amount yh is negative, the output of the heating control signal Ch is zero.

At the time of cooling, the air A is supplied from the air pump 71, and the air A is passed from the air inlet portion 8i into the air path 6. Then, the air A is passed through the air path 6 and is passed out from the air outlet portion 8e to the outside (the atmosphere). In this case, the air A from the air inlet portion 8i is passed into the slit 62i formed in the first panel member 5a, and is passed into the slits 61 from one of the ends of the eight slits 61 formed in the second panel member 5b. Then, the air A passed through the slits 61 reaches the other ends of the slits 61, and is passed into the slit 62e formed in the second panel member 5b and the air A within the slit 62e is passed out from the air outlet portion 8e to the outside. The flow of the air A here is indicated by dotted arrows in FIG. 1. In this way, since the air A passed through the air path 6, in particular, passed through the slits 61 makes contact with the outer circumferential surface 2f of the heating cylinder 2, heat exchange with the heated outer circumferential surface 2f is performed, and thus the outer circumferential surface 2f is forcibly cooled (air-cooled).

Incidentally, the heating and cooling portions 4s are applied to one or two or more heating portions 4 which heat at least the metering zone Zm, the compression zone Zc and the feeding zone Zf in the heating cylinder 2. These zones Zm, Zc and Zf are zones that produce an unnecessary temperature increase caused by shear heat when the resin material is sheared by the rotation of the screw 22. Hence, when the power feed to the band heater 11 is cancelled and natural cooling is depended on without forced cooling being performed, a heating temperature is more likely to become unstable by overshooting or the like. Thus, the power feed to the band heater 11 in the heating and cooling portions 4s is cancelled, and forced cooling by an air-cooling system is performed. In this way, as described previously, it is possible to realize satisfactory temperature control and to contribute to further enhancement of molding quality.

These controls described above are performed according to the sequence control program in the molding machine controller E, and at the time of heating, the heating control signal Ch is fed to the power feed portion 36. At the time of cooling, the cooling control signal Cc is fed from the molding machine controller E to the valve 72. In this case, the heating operation amount yh (the heating control signal Ch) and the cooling operation amount yc (the cooling control signal Cc) are generated by the processing in the PID control system 10, that is, the computation processing based on formulae 1 to 3. A control state shown in FIG. 8 as an example indicates a state where the target temperature (the set temperature) of the intermediate portion is 315.0° C., the current temperature (the detection temperature PV) is 315.1° C., the control output (the heating control signal Ch) on the heating side is 0.0% and the control output (the cooling control signal Cc) on the cooling side is 5.8%. As shown in FIG. 9 as an example, the heating side proportional band Kh is set at 21.4° C. Hence, when the heating side proportional band Kh is lower than 21.4° C., an output of 100% is produced on the heating side. The cooling side proportional band Kc is set at 7.7° C. Hence, when the cooling side proportional band Kc is higher than 7.7° C., an output of 100% is produced on the cooling side. The set values can be automatically set by turning on the keys of the setting key column W6 of auto-tuning.

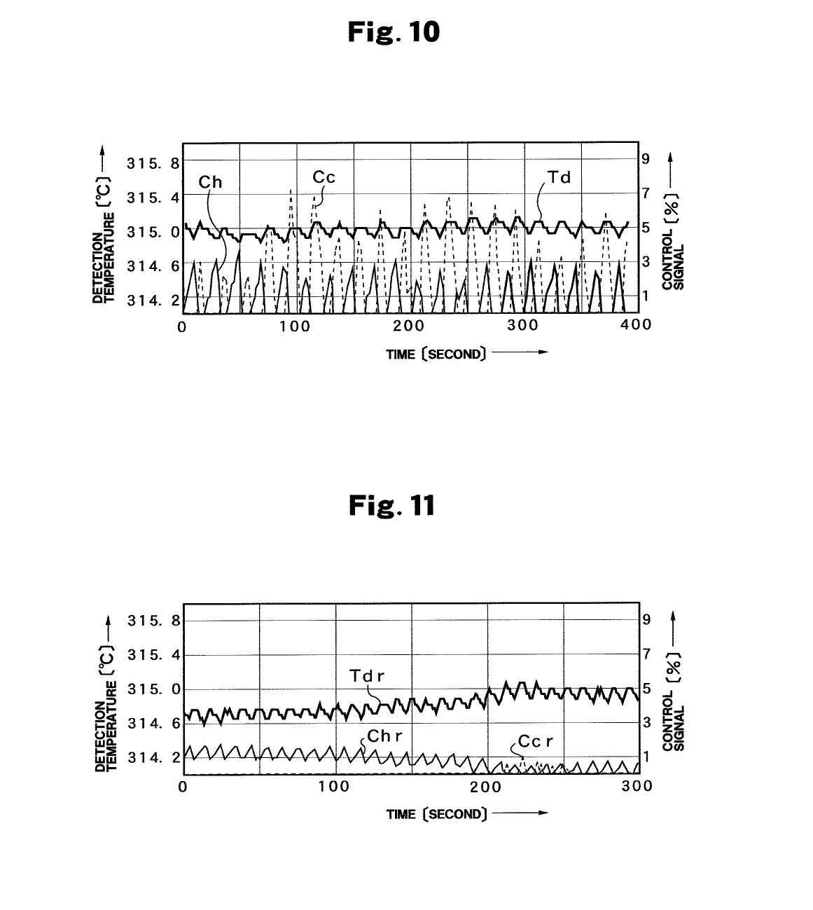

FIG. 10 shows variations in the detection temperature and the control signal (control output) with time when control is performed by the temperature control device 1 according to this embodiment. In FIG. 10, Td represents the detection temperature, Ch represents the heating control signal (heating side control output) and Cc represents the cooling control signal (cooling side control output). It can be clearly seen from FIG. 1 that the heating side control output and the cooling side control output are individually actively performed, the detection temperature falls within a range of ±0.2° C. without significant variations and the control is performed in a stable state. On the other hand, FIG. 11 shows, as a comparative example, variations in the detection temperature and the control signal with time when control is performed by a temperature control device according to background art. In FIG. 11, Tdr represents a detection temperature, Chr represents a control signal on the heating side and Ccr represents a control signal on the cooling side. In this case, it can be found that as compared with the case where the control is performed by the temperature control device 1 according to this embodiment, significant variations in the detection temperature are produced and that the state is unstable.

Hence, in the temperature control device 1 according to this embodiment, the PID control system 10 is included to determine the deviation value e of the detection temperature PV and the set temperature SV, to perform the PID control such that the deviation value e becomes zero and to output, to the corresponding heating portion 4 or cooling portion 5, only one of the heating operation amount yh which is generated by the I operation output, the D operation output, the deviation value e and the heating side proportional band to perform control on the heating portion 4 and the cooling operation amount yc which is generated by the I operation output, the D operation output, the deviation value e and the cooling side proportional band to perform control on the cooling portions 5, whichever amount is relatively larger, with the result that it is possible to perform control in cooperation with the cooling function and the heating function to perform highly stable control while avoiding a hunting phenomenon. Moreover, it is possible to realize the temperature control device 1 having excellent energy saving performance while acquiring high control accuracy, and in particular, the temperature control device 1 is optimal for use in the production of a resin material having a large amount of shear heat when the resin material is sheared by the rotation of a screw.

Although the preferred embodiment is described above in detail, this invention is not limited to such an embodiment, and a change, an addition and a deletion can be arbitrarily made to the detailed configuration, the shape, the material, the number, the value and the like without departing from the spirit of this invention.

For example, since this invention has a temperature control device as a target, the type of heating portion 4 and the cooling portion 5 which is the target to be controlled by the temperature control device 1 are not limited. Specifically, although in the case of the illustrated example, as the heating portion 4, the band heater 11 that incorporates the heating member 12 therewithin and that is fitted by being wound on the outer circumferential surfaces 2f and 2nf of the heating cylinder 2 and the injection nozzle 2n is used, the heating portion 4 is not necessarily limited to the band heater 11; as long as a heating function is included, heating portions 4 based on various principles and structures can be used. Although as the air path 6, the form using the panel member 5p is illustrated, an air-cooling system that is described in the background art and that is performed by an externally installed fan may be adopted, or a cooling means of a water-cooling system in which cooling water is distributed may be adopted. As long as a cooling function is included, cooling portions 5 based on various principles and structures can be used. On the other hand, although in the embodiment, the heating device U including the five heating portions 4 is illustrated, a form including four or less heating portions may be adopted or a form including six or more heating portions may be adopted. Although in the embodiment, the three heating and cooling portions 4s are illustrated, the heating and cooling portion 4s may be applied to only one or two portions especially necessary to be cooled among them or the same heating and cooling portion 4s may be applied even to the other heating portions 4.

### INDUSTRIAL APPLICABILITY

A temperature control device according to this invention can be utilized for various types of injection molding machines having a structure in which a heating cylinder is heated or cooled by a heating portion and a cooling portion provided on the outer circumferential surface of the heating cylinder.

### REFERENCE SIGNS LIST

1: temperature control device, 2: heating cylinder, 2f: outer circumferential surface of heating cylinder, 3: temperature sensor, 4: heating portion, 5: cooling portion, 5p: panel member, 6: air path, 7: air supply portion, 8: air outlet and inlet portion, 10: PID control system, 11: band heater, 12: heating member, 13: selection means, M: injection molding machine, PV: detection temperature, SV: set temperature, E: molding machine controller, e: deviation value, yh: heating operation amount, yc: cooling operation amount, R: material having thermal conductivity, A: air, Zm: metering zone, Zc: compression zone, Zf: feeding zone

### CITATION LIST

Patent Literature 1

JP-No. H11(1999)-115015

1. A temperature control device of an injection molding machine that includes a molding controller which detects, with a temperature sensor, a heating temperature on a predetermined portion of a heating cylinder and which controls a heating portion that heats the predetermined portion and a cooling portion that cools the predetermined portion such that a detection temperature is equal to a preset set temperature, the temperature control device comprising:
a PID control system that determines a deviation value of the detection temperature and the set temperature, that performs PID control such that the deviation value becomes zero and that outputs, to the heating portion or the cooling portion corresponding thereto, only one of a heating operation amount which is generated by an I operation output, a D operation output, the deviation value and a heating side proportional band to perform control on the heating portion and a cooling operation amount which is generated by an I operation output, a D operation output, the deviation value and a cooling side proportional band to perform control on the cooling portion. whichever amount is relatively larger.

2. The temperature control device of an injection molding machine according to claim 1,
wherein the detection temperature is differentiated with respect to time, positive and negative thereof are inverted and an output is produced as the D operation output.

3. The temperature control device of an injection molding machine according to claim 1,
wherein as the heating side proportional band and the cooling side proportional band, individually set reciprocals are used, and the positive and negative of the cooling side proportional band are inverted.

4. The temperature control device of an injection molding machine according to claim 1,
wherein the I operation output and the D operation output generating the heating operation amount and the I operation output and the D operation output generating the cooling operation amount are used in common.

5. The temperature control device of an injection molding machine according to claim 1, the temperature control device further comprising:
a selection means that stops control by the cooling operation amount.

6. The temperature control device of an injection molding machine according to claim 1,
wherein the heating portion incorporates a heating member therewithin, and uses a band heater that is fitted by being wound on an outer circumferential surface of the heating cylinder.

7. The temperature control device of an injection molding machine according to claim 1,
wherein the heating operation amount is converted by a heating control signal conversion portion into a heating control signal, and the heating control signal is used to perform power feed control on the heating portion.

8. The temperature control device of an injection molding machine according to claim 1,
wherein in the cooling portion, a panel member formed of a material having thermal conductivity is interposed between a band heater and an outer circumferential surface of the heating cylinder, in the panel member, an air path for air cooling is formed and in the air path, an air outlet and inlet portion allowing air to be passed from an air supply portion is provided.

9. The temperature control device of an injection molding machine according to claim 8,
wherein the cooling operation amount is converted by a cooling control signal conversion portion into a cooling control signal, and the cooling control signal is used to control supply of air to the cooling portion.

10. The temperature control device of an injection molding machine according to claim 1,
wherein the predetermined portion of the heating cylinder is a metering zone.

11. The temperature control device of an injection molding machine according to claim 1,
wherein the predetermined portion of the heating cylinder is a compression zone.

12. The temperature control device of an injection molding machine according to claim 1,
wherein the predetermined portion of the heating cylinder is a feeding zone.

13. The temperature control device of an injection molding machine according to claim 2,
wherein the I operation output and the D operation output generating the heating operation amount and the I operation output and the D operation output generating the cooling operation amount are used in common.

14. The temperature control device of an injection molding machine according to claim 6,
wherein the heating operation amount is converted by a heating control signal conversion portion into a heating control signal, and the heating control signal is used to perform power feed control on the heating portion.
